(19) United States
(12) Patent Application Publication
(10) Pub. No.: US 2016/0044757 A1
(43) Pub. Date: Feb. 11, 2016

(54) LED DRIVING DEVICE AND LIGHTING APPARATUS

(71) Applicant: SAMSUNG ELECTRONICS CO., LTD., Suwon-si (KR)

(72) Inventor: Nam Su KOO, Yongin-si (KR)

(73) Assignee: SAMSUNG ELECTRONICS CO., LTD., Suwon-si (KR)

(21) Appl. No.: 14/636,600

(22) Filed: Mar. 3, 2015

(30) Foreign Application Priority Data
Aug. 6, 2014 (KR) 10-2014-0101115

(51) Int. Cl. H05B 33/08

(52) U.S. Cl. CPC H05B 33/0845; H05B 33/089

(57) ABSTRACT

A light emitting diode (LED) driving device includes a driving circuit configured to output a driving current for driving a plurality of LEDs using an input voltage, a protection circuit configured to generate a sensing voltage by detecting the input voltage, and a control circuit configured to control the driving circuit by detecting the sensing voltage and the driving current. The protection circuit includes a circuit element having hysteresis characteristics in response to the input voltage that is increased to be greater than a predetermined reference voltage or is decreased to be less than the predetermined reference voltage.

### CROSS-REFERENCE TO THE RELATED APPLICATION

This application claims priority from Korean Patent Application No. 10-2014-0101115 filed on Aug. 6, 2014, with the Korean Intellectual Property Office, the disclosure of which is incorporated herein its entirety by reference.

### BACKGROUND

1. Field

Apparatuses consistent with exemplary embodiments relate to a light emitting diode (LED) driving device and a lighting apparatus.

2. Description of the Related Art

LEDs are widely used as light sources, due to various advantages thereof, such as low power consumption, high degrees of luminance, and the like. Recently, LEDs have been adopted for use in a variety of light emitting devices, such as backlight units for display devices and vehicle headlamps. Such light emitting elements are provided in a form of a package, easily mountable on a wide range of devices. In order to operate stably, LEDs require a driving device for stably outputting a constant current in response to changes in an input voltage.

### SUMMARY

A plurality of exemplary embodiments provide a light emitting diode (LED) driving device which may be able to stably operate LEDs when an input voltage changes within a range close to a minimum voltage required to operate the LED.

According to an exemplary embodiment, there is provided an LED driving device which may include a driving circuit configured to output a driving current for driving a plurality of LEDs using an input voltage, a protection circuit configured to generate a sensing voltage by detecting the input voltage, and a control circuit configured to control the driving circuit by detecting the sensing voltage and the driving current. The protection circuit includes a circuit element having hysteresis characteristics in response to the input voltage that is increased to be greater than a predetermined reference voltage or is decreased to be less than the predetermined reference voltage.

The protection circuit may turn on the circuit element to decrease the sensing voltage in response to the input voltage that is increased to be greater than the predetermined reference voltage.

The control circuit may control the driving circuit to output the driving current in response to the sensing voltage that is decreased to be less than a predetermined threshold voltage.

The driving circuit may include at least one of a boost converter and a buck converter generating a constant current for driving the plurality of LEDs, and the control circuit may control an operation of a switching element included in at least one of the boost converter and the buck converter.

The control circuit may control the operation of the switching element by using the sensing voltage as an analog dimming signal.

In response to the input voltage being decreased, the protection circuit may decrease the sensing voltage such that a decreased level of the sensing voltage is greater than that of the input voltage.

In response to the input voltage being decreased, the control circuit may control the driving circuit to decrease the driving current in response to the decreased level of the sensing voltage.

The driving circuit may further include a current detection circuit including a detection resistor for detecting the driving current and a switching element for cutting off the driving current applied to the plurality of LEDs.

The LED driving device may further include a power supply being configured to generate the input voltage to provide a direct current (DC) voltage to the driving circuit and the protection circuit.

The sensing voltage may be input to one of an input terminal of a comparator included in the control circuit, an input terminal of a dimming circuit included in the control circuit, or an input pin of the control circuit provided as an integrated circuit.

The protection circuit may include a field effect transistor (FET) provided as the circuit element, a voltage dividing resistor configured to divide the input voltage and transfer the divided input voltage to the FET, and a hysteresis resistor connected between a drain terminal and a source terminal of the FET and having hysteresis characteristics.

According to another exemplary embodiment, there is provided an LED driving device which may include a driving circuit including a first switch configured to drive a plurality of LEDs using a driving current, a protection circuit including a second switch configured to be turned on and off according to an input voltage with respect to a predetermined reference voltage and configured to output a sensing voltage, and a control circuit configured to control the first switch of the driving circuit based on the sensing voltage and the driving current.

The second switch may be configured to be turned on to decrease the sensing voltage in response to the input voltage being increased to be greater than the predetermined reference voltage, and the control circuit may be configured to turn off the first switch to output the driving current in response to the sensing voltage that is decreased to be less than a predetermined threshold voltage.

The second switch may be configured to be turned on to decrease the sensing voltage in response to the input voltage being increased to be greater than the predetermined reference voltage. The protection circuit may be configured to decrease the sensing voltage to be less than a predetermined threshold voltage after a predetermined time delay using a time-delay circuit element in response to the second switch that is turned on, and the control circuit may be configured to control the driving circuit to use the driving current in response to the sensing voltage that is decreased to be less than the predetermined threshold voltage.

The driving circuit may further include a detection resistor configured to detect the driving current, and a third switch configured to cut off the driving current applied to the plurality of LEDs in response to the input voltage that is decreased to be less than the predetermined reference voltage.

According to still another exemplary embodiment, there is provided a lighting apparatus which may include a light source including a plurality of LEDs, and the LED driving device described above.

The protection circuit may include a field effect transistor (FET), a voltage dividing resistor configured to divide the input voltage and transfer the divided input voltage to the FET, and a hysteresis resistor connected between a drain terminal and a source terminal of the FET and having hysteresis characteristics.

The protection circuit may decrease the sensing voltage to be less than a predetermined threshold voltage after a predetermined time delay, in response to the input voltage that is increased to be greater than a predetermined reference voltage.

The light source may be a vehicle headlamp.

### BRIEF DESCRIPTION OF THE DRAWINGS

The above and other aspects, features and advantages will be more clearly understood from the following detailed description taken in conjunction with the accompanying drawings, in which:

FIG. 1 is a block diagram schematically illustrating a lighting apparatus, according to an exemplary embodiment;

FIG. 2 is a block diagram schematically illustrating a light emitting diode (LED) driving device, according to an exemplary embodiment;

FIG. 3 is a circuit diagram schematically illustrating an example of a driving circuit applicable to the LED driving device of FIG. 2;

FIG. 4 is a circuit diagram schematically illustrating an example of a protection circuit applicable to the LED driving device of FIG. 2;

FIG. 5 is a circuit diagram illustrating an LED driving device, according to an exemplary embodiment;

FIG. 6 is a graph illustrating an operation of the protection circuit illustrated in FIG. 4, according to an exemplary embodiment;

FIG. 7 is a graph illustrating an operation of the LED driving device illustrated in FIG. 5, according to an exemplary embodiment;

FIGS. 8 and 9 are views illustrating semiconductor light emitting device packages applicable to lighting apparatuses, according to exemplary embodiments; and

FIG. 10 is a view illustrating a lighting apparatus, according to an exemplary embodiment.

### DETAILED DESCRIPTION OF THE EXEMPLARY EMBODIMENTS

Various embodiments will now be described more fully with reference to the accompanying drawings in which some embodiments are shown. The present disclosure may, however, be embodied in different forms and should not be construed as limited to the embodiments set forth herein. Rather, these embodiments are provided so that this disclosure is thorough and complete and fully conveys the present disclosure to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an embodiment can be implemented differently, functions or operations described in a particular block may occur in a different way from a flow described in the flowchart. For example, two consecutive blocks may be performed simultaneously, or the blocks may be performed in reverse according to related functions or operations.

Hereinafter, exemplary embodiments of the present disclosure will be described in detail with reference to the accompanying drawings.

The present disclosure may, however, be embodied in many different forms and should not be construed as being limited to the embodiments set forth herein. Rather, these embodiments are provided such that this present disclosure will be thorough and complete, and will fully convey the scope of the present disclosure to those skilled in the art.

In the drawings, the shapes and dimensions of elements may be exaggerated for clarity, and the same reference numerals will be used throughout to designate the same or like elements.

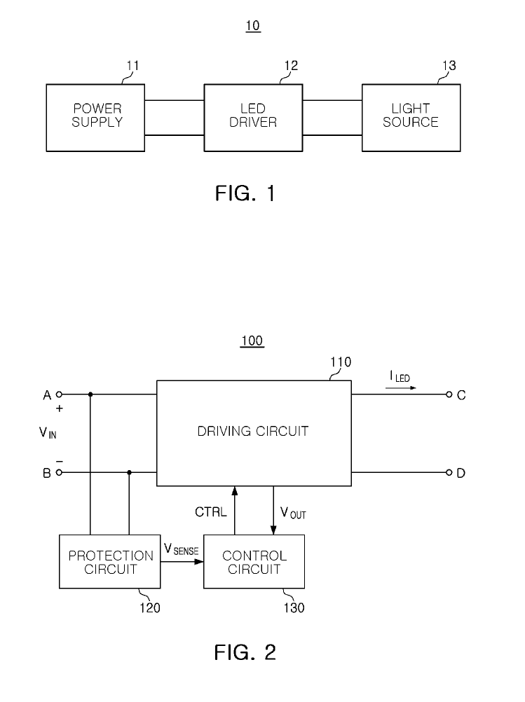

FIG. 1 is a block diagram schematically illustrating a lighting apparatus, according to an exemplary embodiment.

Referring to FIG. 1, a lighting apparatus 10 according to an exemplary embodiment may include a power supply 11, a light emitting diode (LED) driver 12, and a light source 13. The power supply 11 may generate an input voltage required to operate the light source 13, and the input voltage may be a direct current (DC) voltage. In a case in which the lighting apparatus 10 is a vehicle headlamp, the power supply 11 may include a battery provided in a vehicle. Moreover, in a case in which the lighting apparatus 10 is a lighting apparatus for domestic use or for commercial use, the power supply 11 may include an alternating current (AC) power source generating an AC voltage, a rectifier circuit rectifying the AC voltage and generating a DC voltage, and a voltage regulator circuit, and the like.

The LED driver 12 may drive one or more LEDs included in the light source 13 using the input voltage generated by the power supply 11. The LED driver 12 may include a driving circuit generating an LED current for driving the LEDs. The driving circuit may include a DC-DC converter circuit. For example, in a case in which the lighting apparatus 10 is a vehicle headlamp, the LED driver 12 may include a boost converter, and in a case in which the lighting apparatus 10 is a lighting apparatus for domestic use or for commercial use, the LED driver 12 may include a buck converter. The LED driver 12 may also include a control circuit for controlling an operation of a switching element included in the driving circuit. The control circuit may control an operation of a DC-DC converter, for example, a boost converter, a buck converter, or the like, included in the LED driver 12 by using a pulse-width modulation (PWM) dimming scheme or an analog dimming scheme.

The LED driver 12 may detect a DC voltage output from the power supply 11 and an LED current applied to the light source 13, and adjust the LED current applied to the light source 13 based on the detection results. In a case in which the DC voltage is less than a reference voltage required to drive the LEDs, the LED driver 12 may not operate. On the other hand, in a case in which the DC voltage is increased to be greater than the reference voltage required to drive the LEDs, the LED driver 12 may supply the LED current to the light source 13. Further, the LED driver 12 may detect the input voltage and the LED current, and adjust the LED current based on the detection in order to reduce an amount of stress applied to the LEDs included in the light source 13 and prevent reduction in a lifespan of the LEDs. That is, the LED current applied to the light source 13 may be determined based on the input voltage and the LED current detected by the LED driver 12.

FIG. 2 is a block diagram schematically illustrating an LED driving device, according to an exemplary embodiment.

Referring to FIG. 2, according to an exemplary embodiment, an LED driving device 100 may include a driving circuit 110, a protection circuit 120, and a control circuit 130. An input voltage V_{IN}, which is a DC voltage, may be supplied to input terminals A and B of the driving circuit 110. One or more LEDs may be connected to output terminals C and D of the driving circuit 110. The driving circuit 110 may generate an output voltage V_{OUT} corresponding to a current I_{LED} and transfer the output voltage V_{OUT} to the control circuit 130.

The driving circuit 110 may include a converter boosting or bucking the DC input voltage V_{IN}, and generating the current I_{LED} appropriate for driving the LEDs. The converter included in the driving circuit 110 may include at least one switching element adjusting a level of the current I_{LED}. An operation of the switching element included in the driving circuit 110 may be controlled by the control circuit 130. The control circuit 130 may control the operation of the switching element included in the drive circuit 110 by using a PWM dimming scheme or an analog dimming scheme.

According to an exemplary embodiment, the LED driving device 100 may include the protection circuit 120 detecting the input voltage V_{IN} and generating a sensing voltage V_{SENSE} according to the input voltage V_{IN}. The protection circuit 120 may include at least one circuit element having hysteresis characteristics. When the input voltage V_{IN} is increased to be higher than a reference voltage required for an operation of the driving circuit 110, the increase of the input voltage V_{IN} beyond the reference voltage may not be reflected in the sensing voltage V_{SENSE} due to the hysteresis characteristics of the protection circuit 120. Accordingly, the operation of the driving circuit 110 may be relatively stable, as compared to a case in which the control circuit 130 detects, as an input voltage, the input voltage V_{IN} which may be unstable within a range close to the reference voltage, generates a control signal CTRL, and controls the driving circuit 110 to output the current I_{LED}.

The reference voltage may be a minimum voltage required to allow the driving circuit 110 to output the current I_{LED}. When the input voltage V_{IN} is iteratively increased and decreased within the range close to the reference voltage, the operation of the driving circuit 110 may be unstable, and chattering may occur in the LEDs. According to the exemplary embodiment, since the control circuit 130 generates the control signal CTRL using the sensing voltage V_{SENSE} generated by the protection circuit 120 from the input voltage V_{IN}, the chattering of the LEDs caused by changes in the input voltage V_{IN} and the unstable operation of the driving circuit 110 may be prevented. In detail, when the input voltage V_{IN} is increased to be greater than the reference voltage, the changes in the input voltage V_{IN} may be applied to the sensing voltage V_{SENSE} and transferred to the control circuit 130 after a predetermined time delay, due to the hysteresis characteristics of the protection circuit 120; therefore, an amount of stress to be applied to the driving circuit 110 in the range close to the reference voltage may be decreased. Accordingly, an overall lifespan of the driving circuit 110 may be extended and a stable operation thereof may be achieved.

The control circuit 130 may be provided as an analog circuit, a single integrated circuit chip, MICOM, or the like, and may generate the control signal CTRL controlling the operation of the switching element included in the driving circuit 110. The control signal CTRL may be a PWM signal controlling a duty ratio of the switching element. The control circuit 130 may generate the control signal CTRL based on the sensing voltage V_{SENSE} output from the protection circuit 120 and the output voltage V_{OUT} generated by the driving circuit 110. The control circuit 130 may generate the control signal CTRL by using one of the analog dimming scheme or the PWM dimming scheme.

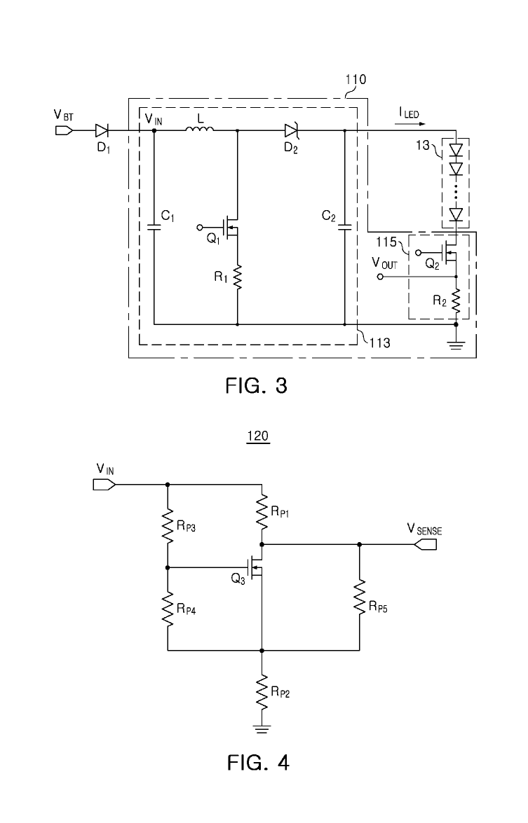

Hereinafter, operations of the driving circuit 110, the protection circuit 120, and the control circuit 130 will be described in more detail with reference to FIGS. 3 through 5.

FIG. 3 is a circuit diagram schematically illustrating an example of a driving circuit applicable to the LED driving device of FIG. 2.

Referring to FIG. 3, according to an exemplary embodiment, the driving circuit 110 may include a DC-DC converter circuit. According to the exemplary embodiment, the driving circuit 110 may include, for example, a boost converter 113. Also, according to the exemplary embodiment, the driving circuit 110 may include a current detection circuit 115 for detecting the current I_{LED} flowing in the LEDs included in the light source 13. The current detection circuit 115 may include a resistor R₂ for detecting the current I_{LED} and a switching element Q₂ for cutting off the current I_{LED}. A control terminal, illustrated as a gate terminal in FIG. 3, of the switching element Q₂ may be connected to the control circuit 130. The control circuit 130 may determine whether to supply the current I_{LED} by controlling ON/OFF switching of the switching element Q₂ based on a level of the input voltage V_{IN}.

As illustrated in FIG. 3, the input voltage V_{IN} supplied to the boost converter 113 may be transferred from a voltage V_{BT}, being a DC voltage. For example, in a case in which the driving circuit 110 is a circuit for driving an LED provided in a vehicle headlamp, the voltage V_{BT} may be a voltage output from a battery provided in a vehicle. The voltage V_{BT} output from the battery may be supplied, as the input voltage V_{IN}, to an input terminal of the boost converter 113 through a diode D₁.

The boost converter 113 may include an inductor L, capacitors C₁ and C₂, a switching element Q₁, a resistor R₁, a zener diode D₂, and the like. In a manner similar to that of the switching element Q₂ included in the current detection circuit 115, a gate terminal of the switching element Q₁ of the boost converter 113 may be connected to the control circuit 130. An operation of the switching element Q₁ may be controlled by a control signal CTRL applied to the gate terminal of the switching element Q₁. In other words, the control circuit 130 may adjust the control signal CTRL by using a PWM dimming scheme or an analog dimming scheme to adjust a turn-on time and a turn-off time of the switching element Q₁.

During a period of time in which the switching element Q₁ is turned on, namely, the turn-on time of the switching element Q₁, the input voltage V_{IN} may not be transferred to the zener diode D₂, and a current may flow into the inductor L, the switching element Q₁, the resistor R₁, and the like. Accordingly, energy may be stored in the inductor L during the turn-on time of the switching element Q₁, and the energy stored in the inductor L may be transferred to the load capacitor C₂ and the LEDs of the light source 13 via the zener diode D₂ during a period of time in which the switching element Q₁ is turned off, namely, the turn-off time of the switching element Q₁. Thus, a level of the current I_{LED} supplied to the LEDs may be determined based on a duty ratio of the switching element Q₁.

FIG. 4 is a circuit diagram schematically illustrating an example of a protection circuit applicable to the LED driving device of FIG. 2.

Referring to FIG. 4, the protection circuit 120 may include a switching element Q₃, and a plurality of resistors R_{P1} through R_{P5}. The switching element Q₃ may operate by the input voltage V_{IN}, and the sensing voltage V_{SENSE} output from the protection circuit 120 may be a voltage measured in a drain terminal of the switching element Q₃.

The switching element Q₃ may start operating when a gate-source voltage V_{GS} is greater than a threshold voltage of the switching element Q₃. The gate-source voltage V_{GS} applied to the resistor R_{P4} connected to a gate terminal and a source terminal of the switching element Q₃ may be represented by Equation 1. A level of the input voltage V_{IN} required for the gate-source voltage V_{GS} to be greater than the threshold voltage of the switching element Q₃ may be defined as a predetermined reference voltage. The reference voltage may be a minimum voltage for the driving circuit 110 to supply the current I_{LED} required for an operation of the light source 13.

$${V}_{GS} = \frac{{R}_{P 4}}{{R}_{P 3} + {R}_{P 4} + {R}_{P 5}} \times {V}_{IN} \qquad ( 1 )$$

In Equation 1, since all resistance values of the resistors R_{P1} through R_{P5} are fixed, in a case in which the input voltage V_{IN} is increased to be greater than the reference voltage, the switching element Q₃ may be turned on. During a period in which the switching element Q₃ is turned off because the input voltage V_{IN} is less than the reference voltage, the sensing voltage V_{SENSE} output from the protection circuit 120 may be expressed by Equation 2.

$${V}_{SENSE} = \frac{{R}_{P 2} + {R}_{P 5}}{{R}_{P 1} + {R}_{P 2} + {R}_{P 5}} \times {V}_{IN} \approx {V}_{IN} \qquad ( 2 )$$

In the protection circuit 120 illustrated in FIG. 4, the resistor R_{P5} connected to the gate terminal and the source terminal of the switching element Q₃ may have a resistance value considerably greater than those of the resistors R_{P1} and R_{P2}. Accordingly, when the switching element Q₃ is turned off, the sensing voltage V_{SENSE} output from the protection circuit 120 may be substantially equal to the input voltage V_{IN}. When the input voltage V_{IN} is increased to be greater than the reference voltage, the switching element Q₃ may be turned on, and the sensing voltage V_{SENSE} may be given by Equation 3.

$${V}_{SENSE} = \frac{{R}_{P 2}}{{R}_{P 1} + {R}_{P 2}} \times {V}_{IN} \qquad ( 3 )$$

In comparing Equation 2 and Equation 3, as the switching element Q₃ is turned on, the resistor R_{P5} having the resistance value considerably greater than those of the resistors R_{P1} and R_{P2} may not have significant influence on determining the sensing voltage V_{SENSE}; therefore, the sensing voltage V_{SENSE} may be decreased. In other words, when the input voltage V_{IN} is increased to allow the switching element Q₃ to enter a turned-on state, the sensing voltage V_{SENSE} output from the protection circuit 120 may be decreased.

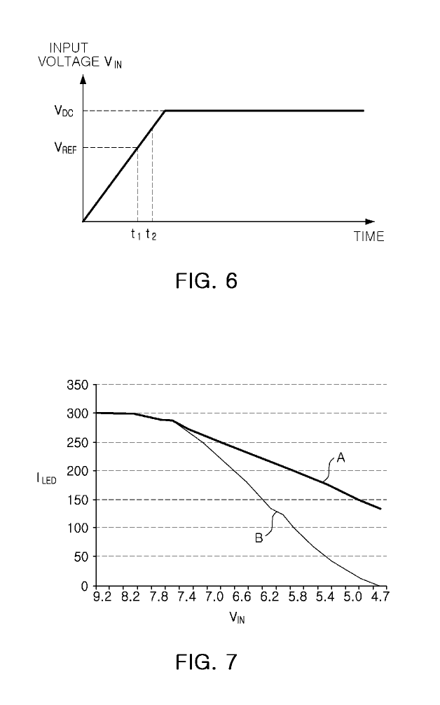

The control circuit 130 operating by recognizing, as an input voltage, the sensing voltage V_{SENSE} rather than the input voltage V_{IN} input to the driving circuit 110 may control the driving circuit 110 to supply the current I_{LED} to the light source 13 when the level of the sensing voltage V_{SENSE} is less than a predetermined threshold voltage. When the input voltage V_{IN} is increased to be greater than the reference voltage such that the switching element Q₃ is turned on and the sensing voltage V_{SENSE} output from the protection circuit 120 is decreased, the control circuit 130 may control the driving circuit 110 to supply the current I_{LED} to the light source 13. Hereinafter, descriptions pertaining to an operation of the protection circuit 120 will be provided with reference to FIG. 6.

FIG. 6 is a graph illustrating an operation of the protection circuit illustrated in FIG. 4.

Referring to FIG. 6, the input voltage V_{IN} may be a DC voltage. The DC input voltage V_{IN} may be gradually increased during a predetermined period of rising time, and supply a predetermined DC voltage V_{DC}. The DC voltage V_{DC} may be greater than a reference voltage V_{REF}. As described hereinbefore, the reference voltage V_{REF} may be a minimum voltage required to allow the driving circuit 110 to supply the current I_{LED} to the light source 13.

When the input voltage V_{IN} is increased to be greater than the reference voltage V_{REF}, the switching element Q₃ of the protection circuit 120 may be turned on, and the sensing voltage V_{SENSE} may be decreased. A predetermined time delay may be required until the sensing voltage V_{SENSE} has a value as represented by Equation 3 after the switching element Q₃ being turned on by the resistor R_{P5} connected to the drain terminal and the source terminal of the switching element Q₃. Accordingly, as illustrated in FIG. 6, the sensing voltage V_{SENSE} may have the value as represented by Equation 3 at a point in time t₂, rather than a point in time t₁, and the control circuit 130 may operate the driving circuit 110 to supply the current I_{LED} to the light source 13.

That is, due to hysteresis characteristics of the switching element Q₃, the predetermined delay time, for example, t₂-t₁, may be required for the sensing voltage V_{SENSE} to be decreased to the value at which the switching element Q₃ may be turned on and the control circuit 130 may operate. Accordingly, chattering of the light source 13, likely to occur during an interval in which the input voltage V_{IN} is iteratively increased and decreased within the range close to the reference voltage V_{REF}, may be prevented, and an amount of stress to be applied to the driving circuit 110, the control circuit 130, and the like, may be reduced.

In a case in which the driving circuit 110 includes a boost converter circuit as illustrated in FIG. 3, when the input voltage V_{IN} is decreased, a current input to the driving circuit 110 may be increased in order to maintain an output power of the driving circuit 110. Accordingly, when the input voltage V_{IN} is decreased, such an increase in the current input to the driving circuit 110 may need to be suppressed to reduce the amount of stress applied to the circuit element included in the driving circuit 110.

According to the exemplary embodiment, when the input voltage V_{IN} is decreased, the sensing voltage V_{SENSE} may be rapidly increased such that a decreased level of the sensing voltage V_{SENSE} is greater than that of the input voltage V_{IN}, and the control circuit 130 may control the operation of the driving circuit 110 to rapidly decrease a level of the current I_{LED} output from the driving circuit 110. In other words, since the decreased level of the current I_{LED} output from the driving circuit 110 is greater than the decreased level of the input voltage V_{IN}, an overcurrent may not be applied to the drive circuit 110 in order to maintain the output of the driving circuit 110. As a result, the amount of stress applied to the driving circuit 110 may be reduced.

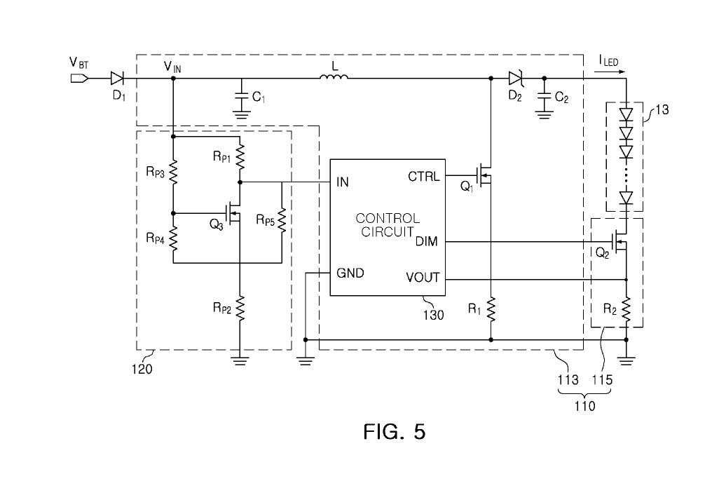

FIG. 5 is a circuit diagram illustrating an LED driving device, according to an exemplary embodiment.

Referring to FIG. 5, according to an exemplary embodiment, the LED driving device 100 may include the driving circuit 110, the protection circuit 120, and the control circuit 130. As described hereinbefore, the driving circuit 110 may include the DC-DC converter supplying the current I_{LED} to the LEDs included in the light source 13. The driving circuit 110 may include the boost converter 113 and the current detection circuit 115 with reference to FIG. 5.

The boost converter 113 may include the switching element Q₁, and the control circuit 130 may adjust ON/OFF switching of the switching element Q₁ and control a magnitude of the current I_{LED} output from the boost converter 113. In a case in which the power supply 11 connected to the driving circuit 110 outputs the voltage V_{BT}, the voltage V_{BT} may be supplied, as the input voltage V_{IN}, to the input terminal of the boost converter 113 via the diode D₁. A noise component included in the input voltage V_{IN} may be removed by the capacitor C1. While the switching element Q₁ is turned on, energy may be stored in the inductor L by the input voltage V_{IN}. The energy stored in the inductor L may be supplied, as the current I_{LED}, to the light source 13 via the zener diode D₂ while the switching element Q₁ is turned off. That is, the current I_{LED} output from the boost converter 113 may be determined by the operation of the switching element Q₁. The control circuit 130 may adjust a duty ratio, or the like, of a signal output through a control PIN PWM using a PWM dimming scheme or an analog dimming scheme, and adjust the turn-on time and the turn-off time of the switching element Q₁.

The current detection circuit 115 may include the switching element Q₂ and the resistor R₂ for current detection. A current detection pin VOUT of the control circuit 130 may be connected to the resistor R₂ to detect the current I_{LED} in a voltage manner. The switching element Q₂ may be connected to a driving pin DIM of the control circuit 130. In a case in which the control circuit 130 outputs a LOW signal via the driving pin DIM, the switching element Q₂ may be turned off and the current I_{LED} supplied to the light source unit 13 may be cut off. Namely, the switching element Q₂ may be used for the control circuit 130 to determine whether to operate the light source 13.

The control circuit 130 may control the operation of the driving circuit 110 using the current I_{LED} detected via the current detection PIN VOUT and an input voltage transferred via an input pin IN. The sensing voltage V_{SENSE} output from the protection circuit 120 may be supplied to the input PIN IN of the control circuit 130. The control circuit 130 may control the driving circuit 110 to operate when the sensing voltage V_{SENSE} is less than a predetermined threshold voltage.

When the DC input voltage V_{IN}, as a DC voltage, starts to be supplied, a period of rising time during which the input voltage V_{IN} is increased to a predetermined DC voltage may be required. On the other hand, in a case in which the input voltage is cut, a period of falling time during which the input voltage V_{IN} is decreased to a ground voltage may be required. In a case in which the operation of the driving circuit 110 is controlled, irrespective of the rising time and the falling time, when a level of the input voltage V_{IN} is close to that of the minimum reference voltage required to operate the driving circuit 110, the operation of the driving circuit 110 may be unstable. According to the exemplary embodiment, the protection circuit 120 may be employed to address the aforementioned issue. Hereinafter, the operation of the protection circuit 120 will be described with reference to FIG. 6.

When the voltage V_{BT} starts to be supplied from the power supply 11, the input voltage V_{IN} may be increased during a predetermined period of rising time. When the input voltage V_{IN} is less than the reference voltage V_{REF}, the switching element Q₃ may maintain a turned-off state, and the sensing voltage V_{SENSE} transferred to the input pin IN of the control circuit 130 may be determined as provided by Equation 2. Since the resistor R_{P5} has a resistance value considerably greater than those of the resistors R_{P1} and R_{P2}, the sensing voltage V_{SENSE} may be substantially equal to the input voltage V_{IN} while the switching element Q₃ is turned off.

When the input voltage V_{IN} is increased to be greater than the reference voltage V_{REF}, the switching element Q₃ may be turned on, and the sensing voltage V_{SENSE}, as represented by Equation 3, may be decreased as compared to a case before the switching element Q₃ is turned on. However, the sensing voltage V_{SENSE} may be gradually decreased by the resistor R_{P5} connected to the drain terminal and the source terminal of the switching element Q₃. Consequently, as illustrated in FIG. 6, the sensing voltage V_{SENSE} may have the value determined by Equation 3 at the point in time t₂, after a predetermined time delay from the point in time t₁ at which the input voltage V_{IN} is increased to be greater than the reference voltage V_{REF}, rather than at the point in time t₁.

Accordingly, the control circuit 130 may operate the driving circuit 110 after the point in time t₂. For example, the control circuit 130 may control to turn on the switching element Q₂ after the point in time t₂ to supply the current I_{LED} to the light source 13, and control to supply a PWM signal having a predetermined duty ratio to the switching element Q₁ to adjust the magnitude of the current I_{LED}.

In the graph of FIG. 6, the reference voltage V_{REF} may be the minimum voltage required to output the current I_{LED} used for the driving circuit 110 to drive the light source 13. According to the exemplary embodiment, a point in time at which the driving circuit 110 outputs the current I_{LED} may be delayed by a predetermined period of time using the hysteresis characteristics of the protection circuit 120; therefore, chattering likely to occur when a level of the input voltage V_{IN} is within the range close to the reference voltage V_{REF} may be resolved.

When the voltage V_{BT} is cut off from the power supply unit 11, the input voltage V_{IN} may be decreased. When the input voltage V_{IN} is decreased to be less than the reference voltage V_{REF}, the sensing voltage V_{SENSE} output from the protection circuit 120 may be increased abruptly. Accordingly, a high level of voltage may be supplied to the input pin IN of the control circuit 130, so that the control circuit 130 may turn the switching element Q₂ off and suspend the operation of the driving circuit 110. Thus, when the input voltage V_{IN} is decreased to be less than the reference voltage V_{REF}, the control circuit 130 may rapidly suspend the operation of the driving circuit 110, thereby reducing an amount of stress applied to the driving circuit 110.

The LED driving device 100 described with reference to FIGS. 3 through 5 may be efficiently applied to an analog dimming operation. In a case in which a magnitude of the current I_{LED} is controlled by using the analog dimming scheme, the current I_{LED} may be decreased in response to a decrease in the input voltage V_{IN}. According to the exemplary embodiment, when the input voltage V_{IN} is decreased to enter a relatively low voltage range, the current I_{LED} may be rapidly decreased; therefore, an amount of stress to be applied to the driving circuit 110 may be minimized. Hereinafter, descriptions pertaining to the operation of the LED driving device 100 will be provided with reference to FIG. 7.

FIG. 7 is a graph illustrating an operation of the LED driving device illustrated in FIG. 5. Referring to FIG. 7, a graph line A, provided as a comparative example, illustrates a case in which the input voltage V_{IN} is supplied to the input PIN IN of the control circuit 130 via a voltage divider. A graph line B, provided as an exemplary embodiment, illustrates a case in which the sensing voltage V_{SENSE} output from the protection circuit 120 is supplied to the input pin IN of the control circuit 130. When the input voltage V_{IN} is decreased to enter a relatively low voltage range, the switching element Q₃ may operate in a linear region while maintaining a turned-on state.

When the input voltage V_{IN} is decreased as illustrated in FIG. 7, the gate-source voltage V_{GS} of the switching element Q₃ may be decreased. As the gate-source voltage V_{GS} of the switching element Q₃ is decreased, a drain current I_{D} and a drain-source voltage V_{DS} may be significantly decreased due to characteristics of the linear region of the switching element Q₃. When the switching element Q₃ operates in the linear region, the sensing voltage V_{SENSE} may be calculated by Equation 4.

V_{SENSE}=V_{DS}+I_{D}×R_{P2} (4)

Since the drain current I_{D} and the drain-source voltage V_{DS} are significantly decreased due to the characteristics of the linear region of the switching element Q₃, the sensing voltage V_{SENSE} may also be significantly decreased. In the analog dimming operation, in a case in which a voltage supplied via the input pin IN is decreased, the control circuit 130 may determine that a voltage input to the driving circuit 110 is decreased, and may decrease a magnitude of the current I_{LED}. Accordingly, in a case in which the analog dimming scheme is applied to the LED driving device 100 provided with the protection circuit 120 according to the exemplary embodiment, the control circuit 130 may rapidly decrease the current I_{LED} when the input voltage V_{IN} is decreased in the relatively low voltage range, and thereby reduce an amount of stress applied to the circuit element included in the driving circuit 110 and enhance reliability of the driving circuit 110.

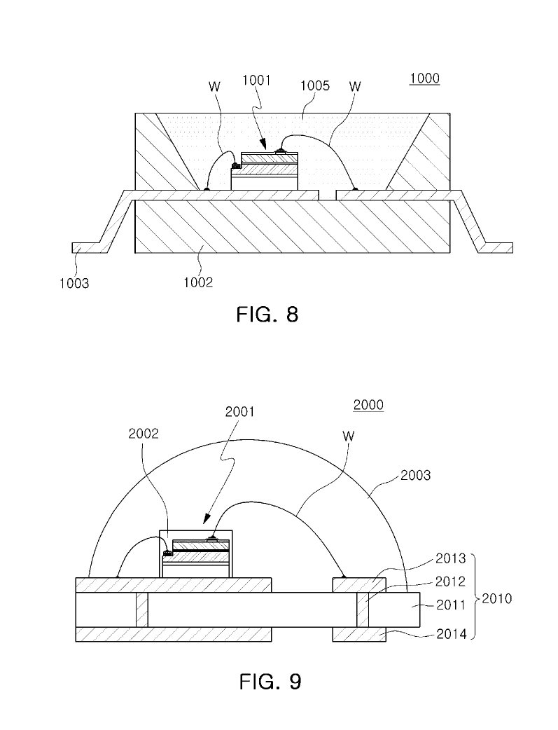

FIGS. 8 and 9 are views illustrating semiconductor light emitting device packages applicable to lighting apparatuses, according to exemplary embodiments.

Referring to FIG. 8, a semiconductor light emitting device package 1000 may include a semiconductor light emitting device 1001, a package main body 1002, and a pair of lead frames 1003. The semiconductor light emitting device 1001 may be mounted on the pair of lead frames 1003 to be electrically connected thereto through a wire W. According to exemplary embodiments, the semiconductor light emitting device 1001 may be mounted on another element, other than the lead frames 1003, for example, on the package main body 1002. Also, the package main body 1002 may have a form of a cup to enhance light reflection efficiency. Such a reflection cup may include a sealing body 1005, formed of a transparent material, to seal the semiconductor light emitting device 1001, the wire W, and the like.

Referring to FIG. 9, a semiconductor light emitting device package 2000 may include a semiconductor light emitting device 2001, a mounting substrate 2010, and a sealing body 2003. Also, a wavelength conversion unit 2002 may be formed on a top surface and a lateral surface of the semiconductor light emitting device 2001. The semiconductor light emitting device 2001 may be mounted on the mounting substrate 2010 to be electrically connected thereto through a wire W and a conductive substrate.

The mounting substrate 2010 may be provided with a substrate main body 2011, an upper electrode 2013, and a lower electrode 2014. Also, the mounting substrate 2010 may include a through electrode 2012 connecting the upper electrode 2013 and the lower electrode 2014. The mounting substrate 2010 may be provided as a printed circuit board (PCB), a metal-core printed circuit board (MCPCB), a metal printed circuit board (MPCB), a flexible printed circuit board (FPCB), or the like, and may be provided in various types of structure.

The wavelength conversion unit 2002 may include a fluorescent material, a quantum dot, or the like. The sealing body 2003 may have a lens structure having a surface provided in a convex dome shape. In exemplary embodiments, an angle of light emitted through a top surface of the sealing body 2003 may be adjusted by forming the surface of the lens structure to have a convex or concave shape.

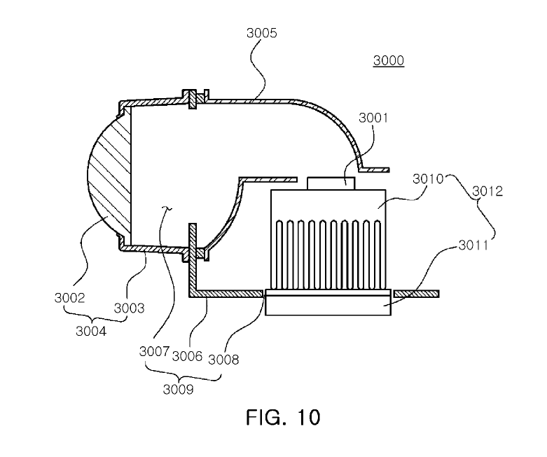

FIG. 10 is a view illustrating a lighting apparatus according to an exemplary embodiment.

Referring to FIG. 10, according to an exemplary embodiment, a lighting apparatus may be applied to a vehicle headlamp.

Referring to FIG. 10, a headlamp 3000 to be employed as a vehicle lighting, or the like, may include a light source unit 3001, a reflection unit 3005, and a lens cover unit 3004. The lens cover unit 3004 may include a hollow guide part 3003 and a lens 3002. The headlamp 3000 may further include a heat radiating unit 3012 dissipating heat generated by the light source unit 3001 externally. The heat radiating unit 3012 may include a heat sink 3010 and a cooling fan 3011 to effectively dissipate heat. Also the headlamp 3000 may further include a housing 3009 for allowing the heat radiating unit 3012 and the reflection unit 3005 to be fixed thereto and supported thereby. The housing 3009 may include a body unit 3006 and a center hole 3008 formed in one surface thereof, to which the heat radiating unit 3012 is coupled.

Additionally, the housing 3009 may include a forwardly open hole 3007 formed in one surface thereof integrally connected to the other surface thereof and bent in a direction perpendicular thereto.

The reflection unit 3005 may be fixed to the housing 3009, such that light generated in the light source unit 3001 may be reflected by the reflection unit 3005, pass through the forwardly open hole 3007, and be emitted outwards.

As set forth above, according to exemplary embodiments, a protection circuit having hysteresis characteristics may generate a sensing voltage from an input voltage, and a drive circuit may detect the sensing voltage and a drive current to be applied to an LED and adjust the drive current. Since an operation of the drive circuit is delayed within a range close to a minimum reference voltage required to operate the LED by an input voltage, due to the hysteresis characteristics of the protection circuit, chattering of the LED likely to occur in a case in which a level of the input voltage is within the range close to the reference voltage level, and the like, may be prevented, and stress to be applied to the drive circuit, the LED, and the like, in a case in which the input voltage is decreased by power being cut off may be avoided.

While exemplary embodiments have been shown and described above, it will be apparent to those skilled in the art that modifications and variations could be made without departing from the scope of the present disclosure as defined by the appended claims.

What is claimed is:

1. A light emitting diode (LED) driving device, comprising:
a driving circuit configured to output a driving current for driving a plurality of LEDs using an input voltage;
a protection circuit configured to generate a sensing voltage by detecting the input voltage, and comprising a circuit element having hysteresis characteristics in response to the input voltage that is increased to be greater than a predetermined reference voltage or is decreased to be less than the predetermined reference voltage; and
a control circuit configured to control the driving circuit by detecting the sensing voltage and the driving current.

2. The LED driving device of claim 1, wherein the protection circuit is configured to turn on the circuit element to decrease the sensing voltage in response to the input voltage that is increased to be greater than the predetermined reference voltage.

3. The LED driving device of claim 2, wherein the control circuit is configured to control the driving circuit to output the driving current in response to the sensing voltage that is decreased to be less than a predetermined threshold voltage.

4. The LED driving device of claim 2, wherein the protection circuit is configured to decrease the sensing voltage to be less than a predetermined threshold voltage after a predetermined time delay in response to the circuit element that is turned on.

5. The LED driving device of claim 4, wherein the control circuit is configured to control the driving circuit to output the driving current in response to the sensing voltage that is decreased to be less than the predetermined threshold voltage.

6. The LED driving device of claim 1, wherein the driving circuit comprises at least one of a boost converter and a buck converter configured to generate a constant current for driving the plurality of LEDs, and
wherein the control circuit is configured to control an operation of a switching element included in at least one of the boost converter and the buck converter.

7. The LED driving device of claim 6, wherein the control circuit is configured to control the operation of the switching element by using the sensing voltage as an analog dimming signal.

8. The LED driving device of claim 1, wherein in response to the input voltage that is decreased, the protection circuit is configured to decrease the sensing voltage such that a decreased level of the sensing voltage is greater than a decreased level of the input voltage.

9. The LED driving device of claim 8, wherein in response to the input voltage that is decreased, the control circuit is configured to control the driving circuit to decrease the driving current according to the decreased level of the sensing voltage.

10. The LED driving device of claim 1, wherein the driving circuit further comprises a current detection circuit comprising a detection resistor configured to detect the driving current and a switching element configured to cut off the driving current applied to the plurality of LEDs.

11. The LED driving device of claim 1, further comprising a power supply configured to generate the input voltage and configured to provide a direct current (DC) voltage to the driving circuit and the protection circuit.

12. The LED driving device of claim 1, wherein the sensing voltage is input to one of an input terminal of a comparator included in the control circuit, an input terminal of a dimming circuit included in the control circuit, or an input pin of the control circuit provided as an integrated circuit.

13. The LED driving device of claim 1, wherein the protection circuit comprises:
a field effect transistor (FET) provided as the circuit element;
a voltage dividing resistor configured to divide the input voltage and transfer the divided input voltage to the FET; and
a hysteresis resistor connected between a drain terminal and a source terminal of the FET and having hysteresis characteristics.

14. A light emitting diode (LED) driving device, comprising:
a driving circuit comprising a first switch configured to drive a plurality of LEDs using a driving current;
a protection circuit comprising a second switch configured to be turned on and off according to an input voltage with respect to a predetermined reference voltage and output a sensing voltage; and
a control circuit configured to control the first switch of the driving circuit based on the sensing voltage and the driving current.

15. The LED driving device of claim 14, wherein the second switch is configured to be turned on to decrease the sensing voltage in response to the input voltage that is increased to be greater than the predetermined reference voltage, and
wherein the control circuit is configured to turn off the first switch to output the driving current in response to the sensing voltage that is decreased to be less than a predetermined threshold voltage.

16. The LED driving device of claim 14, wherein the second switch is configured to be turned on to decrease the sensing voltage in response to the input voltage that is increased to be greater than the predetermined reference voltage,
wherein the protection circuit is configured to decrease the sensing voltage to be less than a predetermined threshold voltage after a predetermined time delay using a time-delay circuit element in response to the second switch that is turned on, and
wherein the control circuit is configured to control the driving circuit to use the driving current in response to the sensing voltage that is decreased to be less than the predetermined threshold voltage.

17. The LED driving device of claim 14, wherein the driving circuit further comprises:
a detection resistor configured to detect the driving current; and
a third switch configured to cut off the driving current applied to the plurality of LEDs in response to the input voltage that is decreased to be less than the predetermined reference voltage.

18. A lighting apparatus, comprising:
a light source including a plurality of light emitting diodes (LEDs);
a power supply configured to generate an input voltage for operating the light source; and
a light emitting diode (LED) driving device including:
a driving circuit configured to output a driving current for driving the plurality of LEDs using the input voltage, the driving circuit including a converter configured to generate the driving current;
a protection circuit configured to generate a sensing voltage by detecting the input voltage, the protection circuit including a circuit element having hysteresis characteristics in response to the input voltage that is increased to be greater than a predetermined reference voltage or is decreased to be less than the predetermined reference voltage; and
a control circuit configured to control the driving circuit by detecting the sensing voltage and the driving current.

19. The lighting apparatus of claim 18, wherein the protection circuit comprises:
a field effect transistor (FET);
a voltage dividing resistor configured to divide the input voltage and transfer the divided input voltage to the FET; and
a hysteresis resistor connected between a drain terminal and a source terminal of the FET, and having hysteresis characteristics.

20. The lighting apparatus of claim 18, wherein the protection circuit is configured to decrease the sensing voltage to be less than a predetermined threshold voltage after a predetermined time delay, in response to the input voltage that is increased to be greater than a predetermined reference voltage.
